(19) United States
(12) Patent Application Publication
(10) Pub. No.: US 2021/0313594 A1
(43) Pub. Date: Oct. 7, 2021

(54) GAS FLOW PATH STRUCTURE, SUPPORT PLATE AND FUEL CELL

(71) Applicant: TOYOTA JIDOSHA KABUSHIKI KAISHA, Toyota-shi (JP)

(72) Inventor: Wataru OTSU, Toyota-shi (JP)

(73) Assignee: TOYOTA JIDOSHA KABUSHIKI KAISHA, Toyota-shi (JP)

(21) Appl. No.: 17/211,406

(22) Filed: Mar. 24, 2021

(30) Foreign Application Priority Data
Apr. 1, 2020 (JP) 2020-065540

(51) Int. Cl. H01M 8/0265; H01M 8/1004; H01M 8/026

(52) U.S. Cl. CPC H01M 8/0265; H01M 8/026; H01M 8/1004

(57) ABSTRACT

To provide a gas flow path structure for fuel cells, which is configured to minimize the occurrence of the blockage of the gas flow path caused by produced water, an increase in the pressure loss of the fuel cell caused by the buckling of a gas diffusion layer, etc., and to obtain stable power generation performance. A gas flow path structure for fuel cells, wherein gas flow paths comprise, within each gas flow path, two or more first regions and two or more second regions having a smaller flow path cross-sectional area than the first regions, and each first region and each second region are alternately disposed within each gas flow path; wherein each first region and each second region are alternately disposed between the adjacent gas flow paths; and wherein the gas flow paths comprise, in each second region, at least one third region having a smaller flow path cross-sectional area than the second region.

### TECHNICAL FIELD

The disclosure relates to a gas flow path structure, a support plate and a fuel cell.

### BACKGROUND

A fuel cell is a power generation device that generates electrical energy by electrochemical reaction between hydrogen (H₂), which serves as fuel gas, and oxygen (O₂), which serves as oxidant gas, in a fuel cell stack composed of stacked unit fuel cells. Hereinafter, fuel gas and oxidant gas may be collectively and simply referred to as “reaction gas” or “gas”.

In general, the unit fuel cells are composed of a membrane electrode assembly (MEA) and, as needed, two separators sandwiching the membrane electrode assembly.

The membrane electrode assembly has such a structure, that a catalyst layer and a gas diffusion layer are formed in this order on both surfaces of a solid polymer electrolyte membrane having proton (H⁺) conductivity (hereinafter, it may be simply referred to as “electrolyte membrane”).

In general, the separators have such a structure that a groove is formed as a reaction gas flow path on a surface in contact with the gas diffusion layer. The separators function as a collector of generated electricity.

In the fuel electrode (anode) of the fuel cell, the hydrogen supplied from the flow path and the gas diffusion layer is protonated by the catalytic activity of the catalyst layer, and the protonated hydrogen goes to the oxidant electrode (cathode) through the electrolyte membrane. An electron is generated at the same time, and it passes through an external circuit, do work, and then goes to the cathode. The oxygen supplied to the cathode reacts with the proton and electron on the cathode, thereby generating water.

The generated water provides the electrolyte membrane with appropriate moisture. Redundant water penetrates the gas diffusion layer, goes through the flow path and then is discharged to the outside of the system.

To increase the power generation performance of a fuel cell, increasing the gas suppliability to an electrode including a catalyst layer and a gas diffusion layer, is under study.

For example, Patent Literature 1 discloses a technique for increasing the power generation performance by increasing the gas suppliability to the electrode in the following manner: a gas flow path is provided with a throttle for partially reducing the cross-sectional area in the gas flow direction, thereby causing a so-called submerged flow, which is the convection of reaction gas flowing from the gas flow path in the gas diffusion layer, and increasing the gas suppliability to the electrode.

Patent Literature 2 discloses a technique for uniformizing the submerged flow amount of each flow path by increasing the flow path width of the central region of the flow path.
Patent Literature 1: Japanese Patent Application Laid-Open (JP-A) No. 2017-228482
Patent Literature 2: JP-A No. 2012-064483

In Patent Literature 1, the submerged gas flow mainly occurs around the throttles of the gas flow path. Accordingly, in the central region between the throttles, the submerged flow is reduced, and the effect of increasing the power generation performance is not sufficiently exerted. The submerged gas flow amount is increased by increasing the number of the throttles (that is, by decreasing the distance between the throttles). However, due to an increase in the number of the portions where the cross-sectional area of the gas flow path is reduced, the blockage of the gas flow path is likely to be caused by produced water, and the gas suppliability to the electrodes is decreased. In addition, due to an increase in the number of the portions where the cross-sectional area of the gas flow path is reduced, the pressure loss of the fuel cell is increased, and the power generation performance of the fuel cell is decreased.

In Patent Literature 2, since the contact area with the gas diffusion layer is reduced in the portions where the rib width of a separator is decreased, the buckling of the gas diffusion layer, which is due to an increase in contact resistance between the separator and the gas diffusion layer and an increase in local surface pressure, may be caused. Accordingly, the gas diffusion layer expands and enters the gas flow path of the separator, thereby reducing the cross-sectional area of the gas flow path. As a result, the blockage of the gas flow path is likely to be caused by produced water, and the gas suppliability to the electrodes is decreased. In addition, since the cross-sectional area of the gas flow path of the separator is reduced, the pressure loss of the fuel cell is increased, and the power generation performance of the fuel cell is decreased.

### SUMMARY

The disclosed embodiments were achieved in light of the above circumstances. A main object of the disclosed embodiments is to provide the gas flow path structure for fuel cells, which is configured to minimize the occurrence of the blockage of the gas flow path caused by produced water, an increase in the pressure loss of the fuel cell caused by the buckling of the gas diffusion layer, etc., and to obtain stable power generation performance.

In a first embodiment, there is provided a gas flow path structure for fuel cells, comprising:

a membrane electrode assembly comprising two electrodes and an electrolyte membrane, wherein each electrode comprises a catalyst layer and a gas diffusion layer, and the electrolyte membrane is disposed between the two catalyst layers;

at least one support plate disposed in adjacent to at least one of the two gas diffusion layers of the membrane electrode assembly; and

groove-shaped gas flow paths formed on a contact surface of the support plate with the at least one gas diffusion layer, wherein the gas flow paths comprise, within each gas flow path, two or more first regions and two or more second regions having a smaller flow path cross-sectional area than the first regions, and each first region and each second region are alternately disposed within each gas flow path;

wherein each first region and each second region are alternately disposed between the adjacent gas flow paths; and

wherein the gas flow paths comprise, in each second region, at least one third region having a smaller flow path cross-sectional area than the second region.

In another embodiment, there is provided a support plate for fuel cells, comprising the above-described gas flow path structure on at least one surface thereof.

In another embodiment, there is provided a fuel cell comprising:

a membrane electrode assembly comprising two electrodes and an electrolyte membrane, wherein each electrode comprises a catalyst layer and a gas diffusion layer, and the electrolyte membrane is disposed between the two catalyst lavers, and

at least one support plate disposed in adjacent to at least one of the two gas diffusion lavers of the membrane electrode assembly,

wherein the support plate comprises the above-described gas flow path structure; and

wherein the gas flow path structure is formed on at least a contact surface of the support plate with the at least one gas diffusion layer.

The disclosed embodiments provide a gas flow path structure for fuel cells, which is configured to minimize the occurrence of the blockage of the gas flow path caused by produced water, an increase in the pressure loss of the fuel cell caused by the buckling of the gas diffusion layer, etc., and to obtain stable power generation performance.

### BRIEF DESCRIPTION OF THE DRAWINGS

In the accompanying drawings,

FIG. 1 is a schematic view of an example of a part of the cross-sectional shape of the gas flow path of the support plate having the gas flow path structure of the disclosed embodiments;

FIG. 2 is a schematic view of an example of the gas flow path arrangement of the gas flow path structure of the disclosed embodiments;

FIG. 3 shows a schematic view of the gas flow path arrangement of the gas flow path structure used in Example 1 (the upper figure) and a view showing the submerged gas flow rate of the gas submerged into the gas diffusion layer at the positions where the gas flow paths were disposed (the lower figure);

FIG. 4 shows a schematic view of the gas flow path arrangement of the gas flow path structure used in Comparative Example 1 (the upper figure) and a view showing the submerged gas flow rate of the gas submerged into the gas diffusion layer at the positions where the gas flow paths were disposed (the lower figure);

FIG. 5 shows a schematic view of the gas flow path arrangement of the gas flow path structure used in Comparative Example 2 (the upper figure) and a view showing the submerged gas flow rate of the gas submerged into the gas diffusion layer at the positions where the gas flow paths were disposed (the lower figure);

FIG. 6 shows a schematic view of the gas flow path arrangement of the gas flow path structure used in Comparative Example 3 (the upper figure) and a view showing the submerged gas flow rate of the gas submerged into the gas diffusion layer at the positions where the gas flow paths were disposed (the lower figure);

FIG. 7 is a view showing a relationship between the pressure loss of the fuel cells of Example 1 and Comparative Examples 1 to 3 and the average submerged gas flow rate of the gas submerged into the gas diffusion layer of the fuel cells;

FIG. 8 is a view showing a relationship between the current density, voltage and pressure loss of the fuel cells of Example 1 and Comparative Example 1 when the batteries were in operation; and

FIG. 9 is a view showing a relationship between the voltage of the fuel cells of Examples 1 to 5 and Comparative Example 1 and the flow path cross-sectional area ratio (the cross-sectional area of wide grooves/the cross-sectional area of narrow grooves) derived from the voltage.

### DETAILED DESCRIPTION

### 1. Gas Flow Path Structure

The gas flow path structure of the disclosed embodiments is a gas flow path structure for fuel cells, comprising:

a membrane electrode assembly comprising two electrodes and an electrolyte membrane, wherein each electrode comprises a catalyst layer and a gas diffusion layer, and the electrolyte membrane is disposed between the two catalyst layers;

at least one support plate disposed in adjacent to at least one of the two gas diffusion layers of the membrane electrode assembly; and

groove-shaped gas flow paths formed on a contact surface of the support plate with the at least one gas diffusion layer,

wherein the gas flow paths comprise, within each gas flow path, two or more first regions and two or more second regions having a smaller flow path cross-sectional area than the first regions, and each first region and each second region are alternately disposed within each gas flow path;

wherein each first region and each second region are alternately disposed between the adjacent gas flow paths; and

wherein the gas flow paths comprise, in each second region, at least one third region having a smaller flow path cross-sectional area than the second region.

A rib (a partition or convex) for separating the gas flow paths on the support plate, is a contact portion with the gas diffusion layer. Accordingly, due to fastening load applied in fuel cell assembly, the gas diffusion layer is collapsed by the rib, thereby decreasing the porosity of the gas diffusion layer and reducing the gas diffusivity and drainage properties of the gas diffusion layer.

By combining three kinds of gas flow path regions having different flow path cross-sectional areas, the submerged gas amounts within each gas flow path are uniformized, and between the different gas flow paths, the surface pressure at the contact portion between the rib and the gas diffusion layer is uniformized. As a result, the gas flow path structure configured to minimize an increase in the pressure loss of fuel cells and to increase the power generation performance thereof, was found.

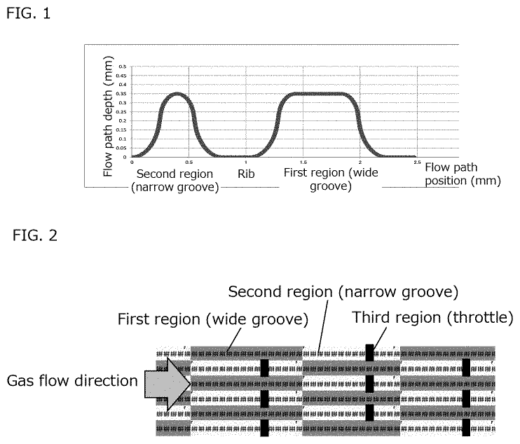

FIG. 1 is a schematic view of an example of a part of the cross-sectional shape of the gas flow path of the support plate having the gas flow path structure of the disclosed embodiments.

In the gas flow path structure of the disclosed embodiments, as shown in FIG. 1, the second regions (narrow grooves) have a smaller flow path cross-sectional area than the first regions (wide grooves).

FIG. 2 is a schematic view of an example of the gas flow path arrangement of the gas flow path structure of the disclosed embodiments. In FIG. 2, the rib is omitted for simplicity.

In the gas flow path structure of the disclosed embodiments, as shown in FIG. 2, the gas flow paths comprise, within each gas flow path, two or more first regions (wide grooves) and two or more second regions (narrow grooves) having a smaller flow path cross-sectional area than the first regions, and each first region and each second region are alternately disposed within each gas flow path. Each first region and each second region are alternately disposed between the adjacent gas flow paths. The gas flow paths comprise, in each second region, at least one third region (throttle) having a smaller flow path cross-sectional area than the second region.

The gas flow path structure of the disclosed embodiments comprises: a membrane electrode assembly comprising two electrodes and an electrolyte membrane, wherein each electrode comprises a catalyst layer and a gas diffusion layer, and the electrolyte membrane is disposed between the two catalyst layers; at least one support plate disposed in adjacent to at least one of the two gas diffusion layers of the membrane electrode assembly; and groove-shaped gas flow paths formed on a contact surface of the support plate with the at least one gas diffusion layer.

The membrane electrode assembly and the support plate will be described later.

The gas flow paths comprise, within each gas flow path, two or more first regions and two or more second regions having a smaller flow path cross-sectional area than the first regions, and each first region and each second region are alternately disposed within each gas flow path.

The flow path cross-sectional area ratio between the first regions (wide grooves) and the second regions (narrow grooves) (i.e., the cross-sectional area of the wide grooves/the cross-sectional area of the narrow grooves) may be more than 1.00. From the viewpoint of increasing the power output of the fuel cell, it may be 1.14 or more, may be 1.42 or more, or may be 1.84 or more. On the other hand, from the viewpoint of increasing the power output of the fuel cell, the flow path cross-sectional area ratio may be 2.74 or less, or it may be 2.24 or less, for example.

In the gas flow paths, the depth of the grooves of the first regions may be the same as or different from the depth of the grooves of the second regions. From the viewpoint of stabilizing the power output of the fuel cell, they may be the same.

Each first region and each second region are alternately disposed between the adjacent gas flow paths. Accordingly, the flow path lengths of the first and second regions of the gas flow path are the same.

The flow path lengths of the first and second regions are not particularly limited. They may be appropriately determined according to the size of the fuel cell.

The numbers of the first and second regions disposed within each gas flow path, are not particularly limited, as long as two or more first regions and two or more second regions are disposed therewithin. The numbers are not particularly limited, and they may be appropriately determined according to the size of the fuel cell.

The gas flow paths comprise, in each second region, at least one third region having a smaller flow path cross-sectional area than the second region.

The flow path cross-sectional area ratio between the second regions (narrow grooves) and the third regions (throttles) (i.e., the cross-sectional area of the narrow grooves/the cross-sectional area of the throttles) may be more than 1.00. From the viewpoint of increasing the power output of the fuel cell, the flow path cross-sectional area ratio may be 3.00 or more, or it may be 5.00 or more. On the other hand, from the viewpoint of increasing the power output of the fuel cell, the flow path cross-sectional area ratio may be 10.00 or less, may be 8.00 or less, or may be 6.00 or less, for example.

In the gas flow path, the depth of the grooves of the second regions may be the same as or different from the depth of the grooves of the third regions. From the viewpoint of stabilizing the power output of the fuel cell, they may be the same.

The flow path length of the third regions is not particularly limited, as long as it is shorter than the flow path length of the second regions.

The flow path length ratio between the second regions (narrow grooves) and the third regions (throttles) (i.e., the length of the narrow grooves/the length of the throttles) may be more than 1.00. From the viewpoint of increasing the power output of the fuel cell, the flow path length ratio may be 3.00 or more, or it may be 5.00 or more. On the other hand, from the viewpoint of increasing the power output of the fuel cell, the flow path length ratio may be 100.00 or less, may be 50.00 or less, or may be 10.00 or less, for example.

The number of the third regions disposed in each second region, is not particularly limited, as long as at least one third region is disposed. From the viewpoint of increasing the power output of the fuel cell, one third region may be disposed in each second region.

In particular, each third region is a throttle. As the third region, a conventionally-known throttle may be used.

The rib may be present between the adjacent gas flow paths of the gas flow path structure.

### 2. Support Plate

The support plate for fuel cells according to the disclosed embodiments, comprises the above-described gas flow path structure.

The support plate may comprise the above-described gas flow path structure on at least one surface thereof, or it may comprise the above-described gas flow path structure on both surfaces thereof.

The support plate is disposed in adjacent to at least one of the two gas diffusion layers of the membrane electrode assembly comprising two electrodes and an electrolyte membrane, wherein each electrode comprises a catalyst layer and a gas diffusion layer, and the electrolyte membrane is disposed between the two catalyst layers.

The support plate may be a separator or a current collector, for example.

The separator may be a gas-impermeable, electroconductive member, etc. As the electroconductive member, examples include, but are not limited to, gas-impermeable dense carbon obtained by carbon densification, and a metal plate obtained by press molding. The separator may have a current collection function.

### 3. Fuel Cell

The fuel cell of the disclosed embodiments is a fuel cell comprising:

a membrane electrode assembly comprising two electrodes and an electrolyte membrane, wherein each electrode comprises a catalyst layer and a gas diffusion layer, and the electrolyte membrane is disposed between the two catalyst layers, and

at least one support plate disposed in adjacent to at least one of the two gas diffusion layers of the membrane electrode assembly,

wherein the support plate comprises the above-described gas flow path structure; and

wherein the gas flow path structure is formed on at least a contact surface of the support plate with the at least one gas diffusion layer.

The fuel cell may be used as a unit fuel cell, and a plurality of the unit fuel cells may be stacked to form a fuel cell stack.

Each unit fuel cell includes the membrane electrode assembly and the support plate disposed on at least one surface of the membrane electrode assembly. Each unit fuel cell may include the membrane electrode assembly and two support plates sandwiching the membrane electrode assembly.

The support plate may have the gas flow path structure on at least the contact surface with the gas diffusion layer, or it may have the gas flow path structure on both surfaces thereof.

The membrane electrode assembly comprises two electrodes and an electrolyte membrane, wherein each electrode comprises a catalyst layer and a gas diffusion layer, and the electrolyte membrane is disposed between the two catalyst layers.

The electrolyte membrane may be a solid polymer material. As the solid polymer electrolyte membrane, examples include, but are not limited to, a hydrocarbon electrolyte membrane and a proton-conducting, ion-exchange membrane formed of a fluorine resin. The electrolyte membrane may be a Nafion membrane (manufactured by DuPont), for example.

The two electrodes each include the catalyst layer and the gas diffusion layer. The first electrode is an oxidant electrode (a cathode), and the second electrode is a fuel electrode (an anode).

The catalyst layer may contain a catalyst metal for accelerating an electrochemical reaction, a proton-conducting electrolyte, or electron-conducting carbon particles, for example.

As the catalyst metal, for example, platinum (Pt) or an alloy of Pt and another metal (such as Pt alloy mixed with cobalt, nickel or the like) may be used.

The electrolyte may be fluorine resin or the like. As the fluorine resin, for example, a Nafion solution may be used.

The catalyst metal is supported on carbon particles. In each catalyst layer, the carbon particles supporting the catalyst metal (i.e., catalyst particles) and the electrolyte may be mixed.

As the carbon particles for supporting the catalyst metal (i.e., supporting carbon particles), for example, water repellent carbon particles obtained by enhancing the water repellency of commercially-available carbon particles (carbon powder) by heating, may be used.

The gas diffusion layer may be a gas-permeable, electroconductive member or the like.

As the electroconductive member, examples include, but are not limited to, a porous carbon material such as carbon cloth and carbon paper, and a porous metal material such as metal mesh and foam metal.

At least one support plate may be disposed in adjacent to at least one of the two gas diffusion layers of the membrane electrode assembly, or the support plate may be disposed in adjacent to each of the two gas diffusion layers of the membrane electrode assembly.

For example, the support plate may be a support plate that functions as a separator or as a current collector.

As the separator, examples include, but are not limited to, the materials exemplified above as the separator in “2. Support plate”.

The gas flow path structure of the support plate may be formed on at least the contact surface of the support plate with the gas diffusion layer, or it may be formed on both surfaces of the support plate.

In general, the membrane electrode assembly is sandwiched between two support plates. A fuel gas flow path is formed between the anode and the first support plate, and an oxygen-containing gas flow path is formed between the cathode and the second support plate.

### EXAMPLES

### Example 1

A fuel cell was prepared, comprising:

a membrane electrode assembly comprising two electrodes and an electrolyte membrane, wherein each electrode comprises a catalyst layer and a gas diffusion layer, and the electrolyte membrane is disposed between the two catalyst layers, and

two support plates disposed in adjacent to the two gas diffusion layers of the membrane electrode assembly,

wherein the two support plates comprise the above-described gas flow path structure; and

wherein the gas flow path structure is formed on the contact surface of each support plate with each gas diffusion layer.

The gas flow path structure of the support plates is as follows:

the gas flow paths comprise, within each gas flow path, a predetermined number of first regions and a predetermined number of second regions having a smaller flow path cross-sectional area than the first regions;

each first region and each second region are alternately disposed within each gas flow path;

each first region and each second region are alternately disposed between the adjacent gas flow paths; and

the gas flow paths comprise, in each second region, one third region having a smaller flow path cross-sectional area than the second region.

The flow path cross-sectional area ratio between the first regions (wide grooves) and the second regions (narrow grooves) (i.e., the cross-sectional area of the wide grooves/the cross-sectional area of the narrow grooves) was set to 1.84.

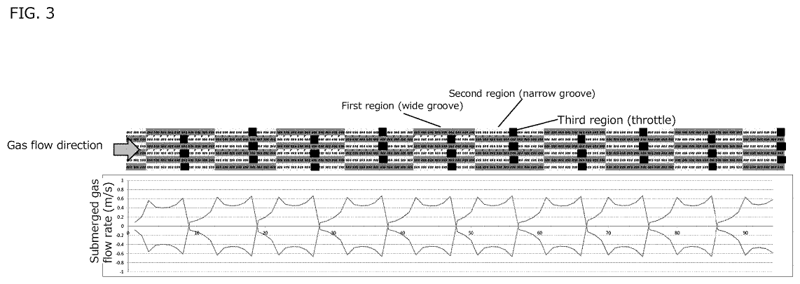

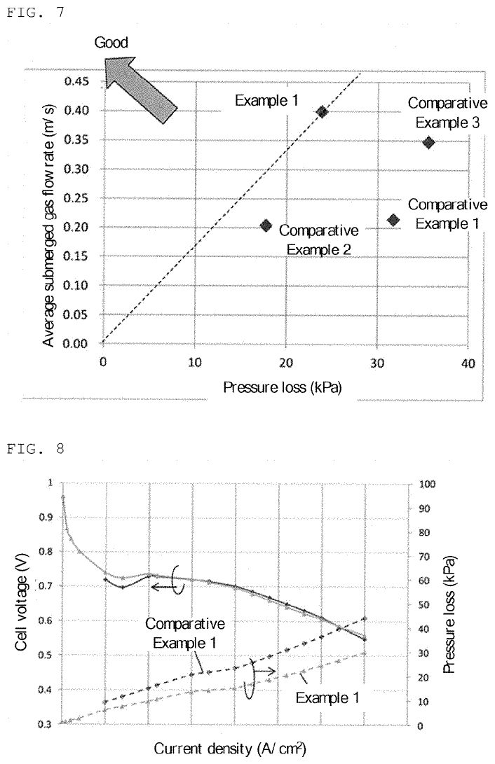

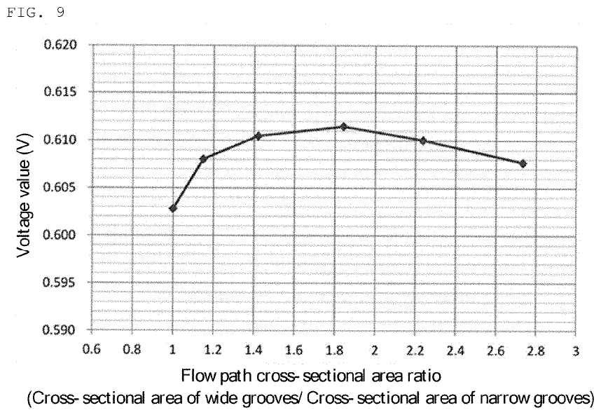

The prepared fuel cell was operated in a predetermined condition, and the pressure loss and voltage of the fuel cell at a predetermined current density, and the average submerged gas flow rate of the gas submerged from the rib of the support plate into the gas diffusion layer, were measured. The results are shown in Table 1, Table 2, FIG. 3, FIG. 7 and FIG. 8.

FIG. 3 shows a schematic view of the gas flow path arrangement of the gas flow path structure used in Example 1 (the upper figure) and a view showing the submerged gas flow rate of the gas submerged into the gas diffusion layer at the positions where the gas flow paths were disposed (the lower figure).

In Example 1, the pressure loss was 24 kPa; the voltage was 0.6115 V; and the average submerged gas flow rate was 0.40 m/s.

### Comparative Example 1

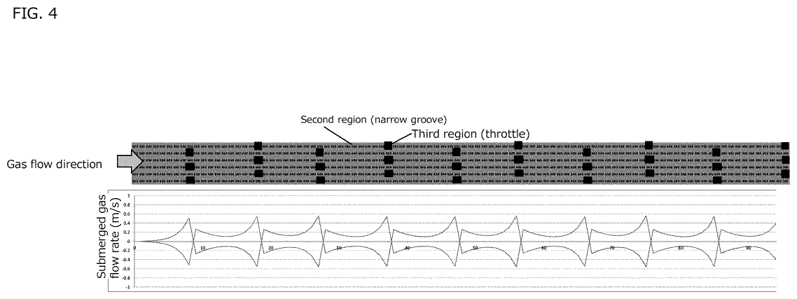

A fuel cell was prepared in the same manner as Example 1, except that the flow path cross-sectional area ratio between the first regions (wide grooves) and the second regions (narrow grooves) (i.e., the cross-sectional area of the wide grooves/the cross-sectional area of the narrow grooves) of the gas flow path structure was set to 1.00. The pressure loss and voltage of the fuel cell at the predetermined current density, and the average submerged gas flow rate of the gas submerged from the rib of the support plate into the gas diffusion layer, were measured in the same manner as Example 1. The results are shown in Table 1, Table 2, FIG. 4, FIG. 7 and FIG. 8.

FIG. 4 shows a schematic view of the gas flow path arrangement of the gas flow path structure used in Comparative Example 1 (the upper figure) and a view showing the submerged gas flow rate of the gas submerged into the gas diffusion layer at the positions where the gas flow paths were disposed (the lower figure).

In Comparative Example 1, the pressure loss was 32 kPa; the voltage was 0.6030 V; and the average submerged gas flow rate was 0.21 m/s.

### Comparative Example 2

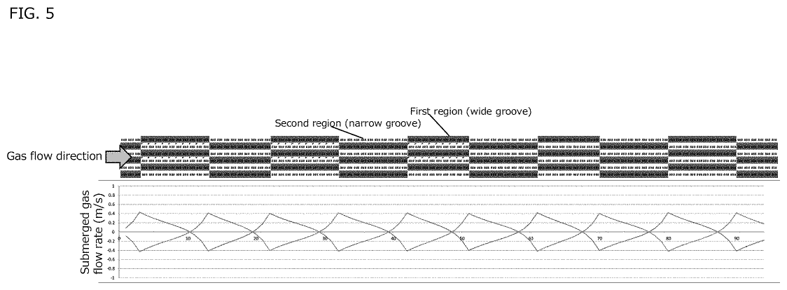

A fuel cell was prepared in the same manner as Example 1, except that the third region was not disposed in the gas flow path structure. The pressure loss of the fuel cell at the predetermined current density and the average submerged gas flow rate of the gas submerged from the rib of the support plate into the gas diffusion laver, were measured in the same manner as Example 1. The results are shown in Table 1, FIG. 5 and FIG. 7.

FIG. 5 shows a schematic view of the gas flow path arrangement of the gas flow path structure used in Comparative Example 2 (the upper figure) and a view showing the submerged gas flow rate of the gas submerged into the gas diffusion layer at the positions where the gas flow paths were disposed (the lower figure).

In Comparative Example 2, the pressure loss was 18 kPa, and the average submerged gas flow rate was 0.20 m/s.

### Comparative Example 3

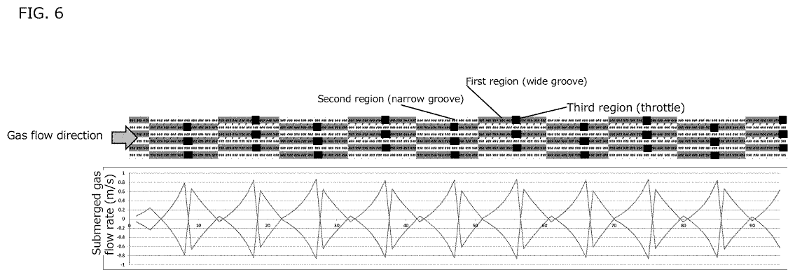

A fuel cell was prepared in the same manner as Example except that instead of disposing the third region in each second region of the gas flow path structure, one third region was disposed in each first region. The pressure loss of the fuel cell at the predetermined current density and the average submerged gas flow rate of the gas submerged from the rib of the support plate into the gas diffusion layer, were measured in the same manner as Example 1. The results are shown in Table 1, FIG. 6 and FIG. 7.

FIG. 6 shows a schematic view of the gas flow path arrangement of the gas flow path structure used in Comparative Example 3 (the upper figure) and a view showing the submerged gas flow rate of the gas submerged into the gas diffusion layer at the positions where the gas flow paths were disposed (the lower figure).

In Comparative Example 3, the pressure loss was 35 kPa, and the average submerged gas flow rate was 0.35 m/s.

TABLE 1

| | Flow path cross- | | | |
|---|---|---|---|---|
| | sectional area | | | |
| | ratio (The cross- | | | |
| | sectional area | | | |
| | of the | | | |
| | wide grooves/ | | | |
| | The cross- | | | Average |
| | sectional | Position where | Pressure | submerged |
| | area of the | the third region | loss | gas flow rate |
| | narrow grooves) | was disposed | (kPa) | (m/s) |
| Example 1 | 1.84 | In each | 24 | 0.40 |
| | | second region | | |
| Comparative | 1.00 | In each | 32 | 0.21 |
| Example 1 | | second region | | |
| Comparative | 1.84 | — | 18 | 0.20 |
| Example 2 | | | | |
| Comparative | 1.84 | In each first | 35 | 0.35 |
| Example 3 | | region | | |

FIG. 7 is a view showing a relationship between the pressure loss of the fuel cells of Example 1 and Comparative Examples 1 to 3 and the average submerged gas flow rate of the gas submerged into the gas diffusion layer of the fuel cells.

FIG. 8 is a view showing a relationship between the current density, voltage and pressure loss of the fuel cells of Example 1 and Comparative Example 1 when the batteries were in operation. In FIG. 8, solid lines indicate the voltage, and dashed lines indicate the pressure loss. Also in FIG. 8, triangles indicate the values of Example 1, and rhombi indicate the values of Comparative Example 1.

As shown in Table 1, the pressure loss of the fuel cell of Example 1 is lower than the fuel cells of Comparative Examples 1 and 3, and the average submerged gas flow rate of the fuel cell of Example 1 is larger than the fuel cells of Comparative Examples 1 to 3. Accordingly, it was revealed that by using the support having the gas flow path structure of the disclosed embodiments in the fuel cell, an increase in the pressure loss is suppressed, and the average submerged gas flow rate is increased; therefore, and the fuel cell obtains stable power generation performance.

### Example 2

A fuel cell was prepared in the same manner as Example 1, except that the flow path cross-sectional area ratio between the first regions (wide grooves) and the second regions (narrow grooves) (i.e., the cross-sectional area of the wide grooves/the cross-sectional area of the narrow grooves) of the gas flow path structure, was set to 1.15. The voltage of the fuel cell at the predetermined current density, was measured in the same manner as Example 1. The result is shown in Table 2 and FIG. 9.

In Example 2, the voltage was 0.6080 V.

### Example 3

A fuel cell was prepared in the same manner as Example 1, except that the flow path cross-sectional area ratio between the first regions (wide grooves) and the second regions (narrow grooves) (i.e., the cross-sectional area of the wide grooves/the cross-sectional area of the narrow grooves) of the gas flow path structure, was set to 1.42. The voltage of the fuel cell at the predetermined current density, was measured in the same manner as Example 1. The result is shown in Table 2 and FIG. 9.

In Example 3, the voltage was 0.6105 V.

### Example 4

A fuel cell was prepared in the same manner as Example 1, except that the flow path cross-sectional area ratio between the first regions (wide grooves) and the second regions (narrow grooves) (i.e., the cross-sectional area of the wide grooves/the cross-sectional area of the narrow grooves) of the gas flow path structure, was set to 2.24. The voltage of the fuel cell at the predetermined current density, was measured in the same manner as Example 1. The result is shown in Table 2 and FIG. 9.

In Example 4, the voltage was 0.6100 V.

### Example 5

A fuel cell was prepared in the same manner as Example 1, except that the flow path cross-sectional area ratio between the first regions (wide grooves) and the second regions (narrow grooves) (i.e., the cross-sectional area of the wide grooves/the cross-sectional area of the narrow grooves) of the gas flow path structure, was set to 2.74. The voltage of the fuel cell at the predetermined current density, was measured in the same manner as Example 1. The result is shown in Table 2 and FIG. 9.

In Example 5, the voltage was 0.6078 V.

TABLE 2

| | Flow path cross-sectional area ratio | |
|---|---|---|
| | (The cross-sectional area of the | |
| | wide grooves/The cross-sectional | Voltage |
| | area of the narrow grooves) | (V) |
| Comparative | 1.00 | 0.6030 |
| Example 1 | | |
| Example 2 | 1.15 | 0.6080 |
| Example 3 | 1.42 | 0.6105 |
| Example 1 | 1.84 | 0.6115 |
| Example 4 | 2.24 | 0.6100 |
| Example 5 | 2.74 | 0.6078 |

FIG. 9 is a view showing a relationship between the voltage of the fuel cells of Examples 1 to 5 and Comparative Example 1 and the flow path cross-sectional area ratio (i.e., the cross-sectional area of the wide grooves/the cross-sectional area of the narrow grooves) derived from the voltage.

As shown in Table 2 and FIG. 9, it was proved that the fuel cell voltage is high when the flow path cross-sectional area ratio is in a range of from 1.15 to 2.74, and the fuel cell voltage is the highest when the flow path cross-sectional area ratio is 1.84.

1. A gas flow path structure for fuel cells, comprising:
a membrane electrode assembly comprising two electrodes and an electrolyte membrane, wherein each electrode comprises a catalyst layer and a gas diffusion layer, and the electrolyte membrane is disposed between the two catalyst lavers;
at least one support plate disposed in adjacent to at least one of the two gas diffusion layers of the membrane electrode assembly; and
groove-shaped gas flow paths formed on a contact surface of the support plate with the at least one gas diffusion layer,
wherein the gas flow paths comprise, within each gas flow path, two or more first regions and two or more second regions having a smaller flow path cross-sectional area than the first regions, and each first region and each second region are alternately disposed within each gas flow path;
wherein each first region and each second region are alternately disposed between the adjacent gas flow paths; and
wherein the gas flow paths comprise, in each second region, at least one third region having a smaller flow path cross-sectional area than the second region.

2. A support plate for fuel cells, comprising the gas flow path structure defined by claim 1 on at least one surface thereof.

3. A fuel cell comprising:
a membrane electrode assembly comprising two electrodes and an electrolyte membrane, wherein each electrode comprises a catalyst layer and a gas diffusion layer, and the electrolyte membrane is disposed between the two catalyst layers, and
at least one support plate disposed in adjacent to at least one of the two gas diffusion layers of the membrane electrode assembly,
wherein the support plate comprises the gas flow path structure defined by claim 1; and
wherein the gas flow path structure is formed on at least a contact surface of the support plate with the at least one gas diffusion layer.
